(19) United States
(12) Patent Application Publication
(10) Pub. No.: US 2009/0188365 A1
(43) Pub. Date: Jul. 30, 2009

(54) Base For A Paper Punch And Method Of Forming Same

(75) Inventor: Kwok Ki Stephen Chan, New Territories (HK)

Correspondence Address: WILLIAM J. SAPONE;COLEMAN SUDOL SAPONE P.C., 714 COLORADO AVENUE, BRIDGE PORT, CT, 06605, US

(73) Assignee: Lee Tack Plastic & Metal Manufactory Ltd., New Territories (HK)

(21) Appl. No.: 12/019,685

(22) Filed: Jan. 25, 2008

(51) Int. Cl. B26D 7/00; B23P 11/00; B26D 1/10; B26D 7/01

(52) U.S. Cl. 83/613; 29/428; 29/525.01; 29/525.11; 83/859

(57) ABSTRACT

A method of forming a base for a paper punch is disclosed as including the steps of (a) forming two generally U-shaped plates of a first metal or metal alloy, and (b) fixedly engaging the generally U-shaped plates with a core part of a second metal or metal alloy, in which the plates are in direct contact with the core part. A base for a paper punch is disclosed as including two generally U-shaped plates of a first metal or metal alloy, and a core part of a second metal or metal alloy which is fixedly engaged with the U-shaped plates, and the plates are in direct contact with the core part.

This invention relates to a base for a paper punch and a method of forming such a base and, in particular, such a base for a paper punch suitable for paper crafting purposes.

### BACKGROUND OF THE INVENTION

In the field of paper crafting, pieces of paper or cardboard of various shapes are punched out from sheets of paper or cardboard by paper punches. A conventional paper punch is shown in FIGS. 1 and 2, generally designated as 10. The paper punch 10 has an operating handle 12 operatively associated with a body 14. A generally horizontal slot 16 is provided in the body 14 allowing insertion of a sheet of paper or cardboard 18. The operating handle 12 may then be pivoted downwardly to move a punch die 22 (see FIG. 4) to punch or cut out a piece of shaped paper or cardboard 18a from the piece of paper or cardboard 18, as shown in FIG. 3.

As shown in FIGS. 4 and 5, the operating handle 12 is pivotable about a point 20 to bear down on the punch die 22, which may be made of a metal or metal alloy, to move through a slot 24 between an upper jaw 26 and a lower jaw 28 of an integrally formed metal base 30 to perform the cutting action. Upon release of the downward pressing force, a spring 32 between the punch die 22 and the base 30 acts to return the punch die 22 to the upper stable position as shown in FIG. 4.

In such a conventional paper punch, the punch die and the punch base (also called a “die holder”) are made integrally of a metal or metal alloy (such as copper, aluminum, silver, zinc, tin or their alloy) by low pressure die casting, e.g. by injection molding. Although it has been known that the cost of the paper punch may be reduced if at least part of the base is made of a different metal or metal alloys, it has not hitherto been possible to achieve such a result without compromising the strength of the base.

It is thus an object of the present invention to provide a base for a paper punch, a paper punch with such a base, and a method of forming such a base in which the base is formed of at least two parts which are each of a different metal or metal alloy.

### SUMMARY OF THE INVENTION

According to a first aspect of the present invention, there is provided a method of forming a base for a paper punch, including the steps of (a) forming at least two generally U-shaped plate members of a first metal or metal alloy, and (b) fixedly engaging said generally U-shaped plate members with a core part of a second metal or metal alloy, wherein at least part of each said plate members is in direct contact with at least part of said core part.

According to a second aspect of the present invention, there is provided a base for a paper punch, including at least two generally U-shaped plate members of a first metal or metal alloy, and a core part of a second metal or metal alloy which is fixedly engaged with said U-shaped plate members, wherein at least part of each said plate members is in direct contact with at least part of said core part.

According to a third aspect of the present invention, there is provided a paper punch including a die and a base, wherein said base is formed by a method including the steps of (a) forming at least two generally U-shaped plate members of a first metal or metal alloy, and (b) fixedly engaging said generally U-shaped plate members with a core part of a second metal or metal alloy, wherein at least part of each said plate members is in direct contact with at least part of said core part.

According to a fourth aspect of the present invention, there is provided a paper punch including a die and a base, said base including at least two generally U-shaped plate members of a first metal or metal alloy, and a core part of a second metal or metal alloy which is fixedly engaged with said U-shaped plate members, wherein at least part of each said plate members is in direct contact with at least part of said core part.

### BRIEF DESCRIPTION OF THE DRAWINGS

Preferred embodiments of the present invention will now be described, by way of examples only, with reference to the accompanying drawings, in which:

FIG. 1 shows a side view of a conventional paper punch;

FIG. 2 is a top perspective view of the paper punch shown in FIG. 1;

FIG. 3 shows a piece of shaped paper cut out by the paper punch shown in FIG. 2;

FIG. 4 is a longitudinal sectional view of the conventional paper punch shown in FIG. 1;

FIG. 5 is an exploded view of the die and base of the paper punch of FIG. 4;

FIG. 6 shows two generally U-shaped plate members suitable for incorporation in a base of a paper punch according to a first preferred embodiment of the present invention;

FIG. 7 shows a first step in the moulding process for forming a base of a paper punch according to a first preferred embodiment of the present invention;

FIG. 8 shows a second step in the moulding process, subsequent to that shown in FIG. 7;

FIG. 9 shows a base formed of the moulding process shown in FIGS. 7 and 8;

FIG. 10 is a sectional view taken along the line A-A in FIG. 9;

FIG. 11 is an enlarged view of the encircled part in FIG. 10;

FIGS. 12 and 13 show steps of forming a slot in the core part of the base shown in FIG. 9;

FIG. 14 shows a base after having undergone the steps shown in FIGS. 12 and 13;

FIG. 15 shows engagement of the base shown in FIG. 14 with a bottom plate to form a body of a paper punch according to the first preferred embodiment of the present invention;

FIG. 16 is a sectional view taken along the line B-B of FIG. 15;

FIG. 17 is an enlarged view of the encircled part in FIG. 16;

FIG. 18 is a sectional view taken along the line C-C of FIG. 15;

FIG. 19 is an enlarged view of the encircled part in FIG. 18;

FIG. 20 is an exploded view of a paper punch incorporating the base shown in FIG. 14;

FIG. 21 is a transverse sectional view of the paper punch shown in FIG. 20, as assembled;

FIG. 22 shows a core part for incorporation in a base of a paper punch according to a second preferred embodiment of the present invention;

FIGS. 23 and 24 show steps of forming a slot in the core part shown in FIG. 22;

FIG. 25 shows a core part after having undergone the steps shown in FIGS. 23 and 24;

FIG. 26 shows two generally U-shaped plate members for engagement with the core part shown in FIG. 25 for forming a base of a paper punch according to the second preferred embodiment of the present invention;

FIG. 27 shows engagement of the two U-shaped plate members shown in FIG. 26 with the core part shown in FIG. 25;

FIG. 28 shows the two U-shaped plate members and core part shown in FIG. 27 to be fixedly engaged with each other via a number of screws;

FIG. 29 shows the two U-shaped plate members and core part shown in FIG. 28 fixedly engaged with each other forming a base of a paper punch according to the second preferred embodiment of the present invention;

FIG. 30 shows engagement of the base shown in FIG. 29 with a bottom plate to form a body of a paper punch according to the second preferred embodiment of the present invention;

FIG. 31 is a sectional view taken along the line D-D of FIG. 30;

FIG. 32 is an enlarged view of the encircled part in FIG. 31;

FIG. 33 is a sectional view taken along the line E-E of FIG. 30;

FIG. 34 shows two generally U-shaped plate members for incorporation in a base of a paper punch according to a third preferred embodiment of the present invention;

FIG. 35 is a core part for incorporation in a base of a paper punch according to the third preferred embodiment of the present invention;

FIG. 36 shows the two U-shaped plate members shown in FIG. 34 and the core part shown in FIG. 35 to be fixedly engaged with each other;

FIG. 37 shows the U-shaped plate members and core part shown in FIG. 36 engaged with each other;

FIG. 38 is a transverse sectional view of the base, showing deformation of part of the core part for fixed engagement with the U-shaped plate members shown in FIG. 37;

FIG. 39 is an enlarged view of the encircled part shown in FIG. 38;

FIG. 40 is a partly sectioned view of the base showing engagement of the U-shaped plate members with the core part via rivets;

FIG. 41 is an enlarged view of the encircled part of FIG. 40;

FIG. 42 shows a step of forming a slot in the base shown in FIG. 40;

FIG. 43 shows the base after the step shown in FIG. 42;

FIG. 44 shows engagement of the base shown in FIG. 43 with a bottom plate to form a body of a paper punch according to the third preferred embodiment of the present invention;

FIG. 45 is a sectional view taken along the line F-F of FIG. 44;

FIG. 46 is an enlarged view of the encircled part in FIG. 45; and

FIG. 47 is a sectional view taken along the line G-G of FIG. 44.

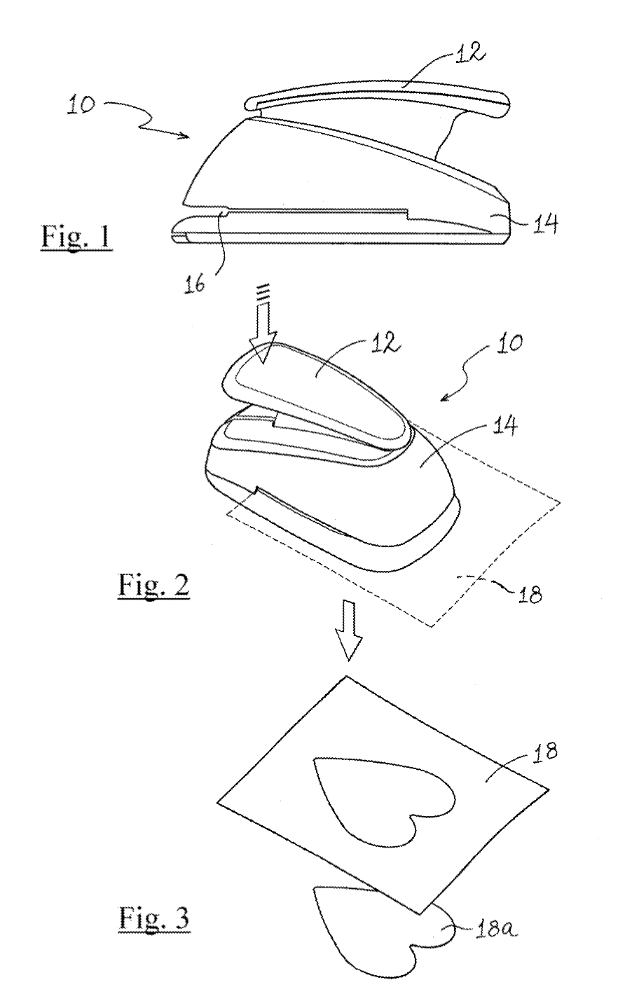

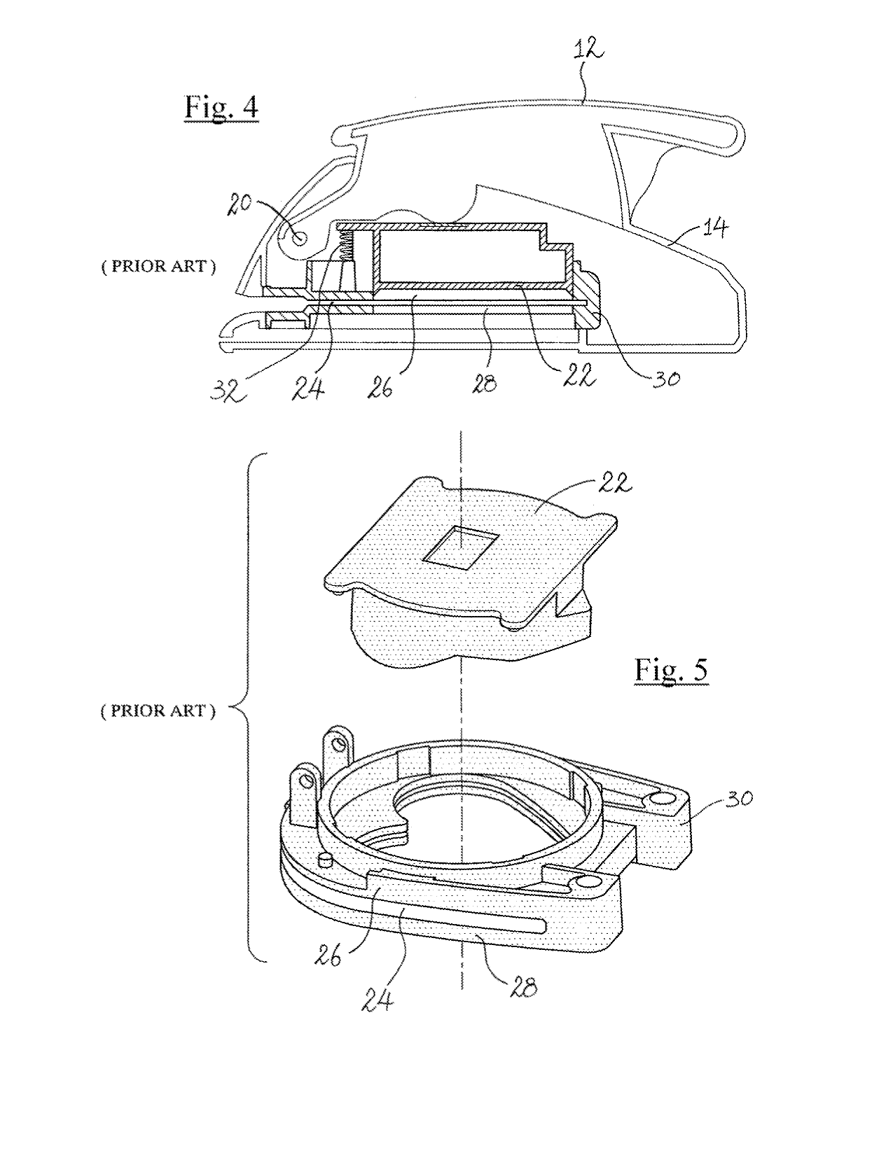

### DETAILED DESCRIPTION OF THE PREFERRED EMBODIMENTS

Although the present invention will hereinafter be referred to as and described in the context of a base for a paper punch and a paper punch with such a base, it is also envisaged that a paper punch according to the present invention is also suitable for punching cardboard and such like paper materials, and that the scope of protection should be construed accordingly.

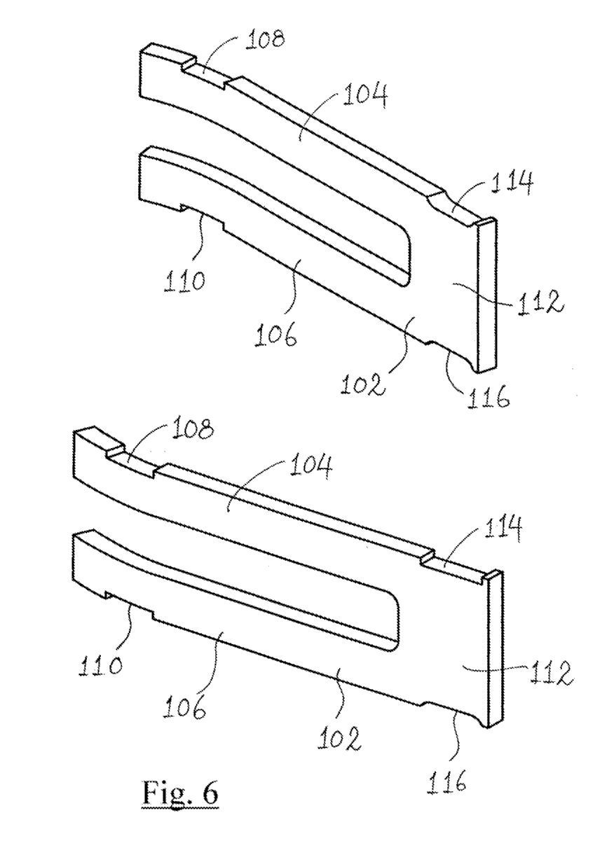

Referring now to FIG. 6, such shows two integrally formed generally U-shaped steel plates 102, each having a first leg 104 and a second leg 106 which are parallel with each other. Adjacent a free end of each first leg 104 is an upper trough 108, and adjacent a free end of each second leg 106 is a lower trough 110. For each steel plate 102, the first leg 104 is joined with the respective second leg 106 via a generally rectangular portion 112. The rectangular portion 112 is also provided with an upper trough 114 and a lower trough 116.

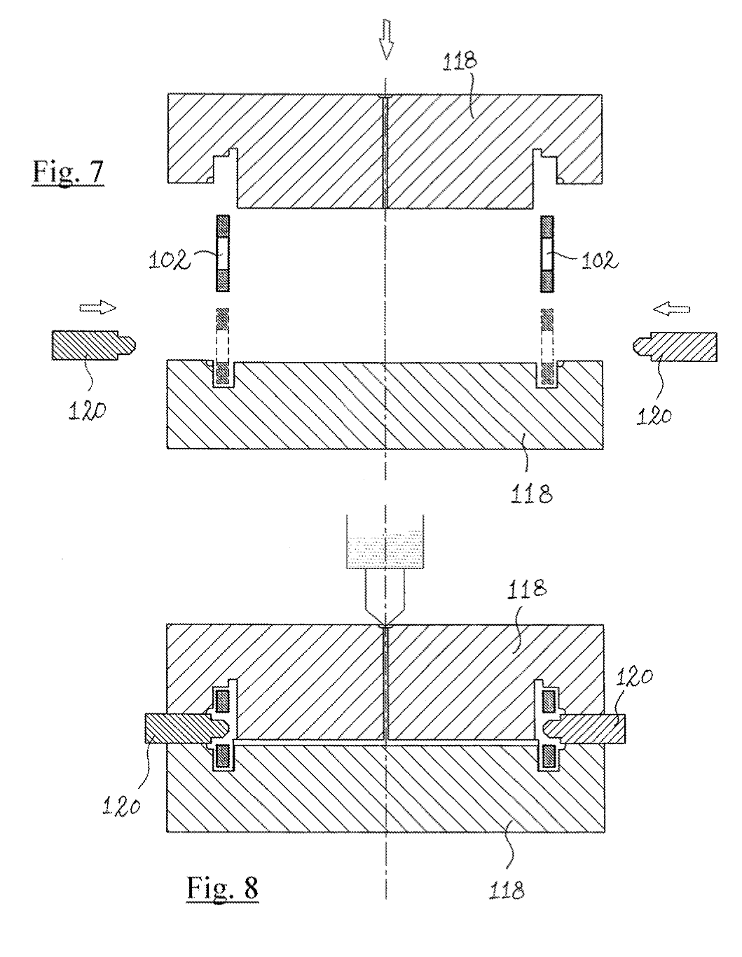

As shown in FIGS. 7 and 8, the two generally U-shaped steel plates 102 are positioned within a mould pair 118, into which a metal or metal alloy, e.g. copper, aluminium, silver, zinc, tin or their alloy, is injected through a number of nozzles 120, so as to mould the metal or metal alloy over and around the steel plates 102.

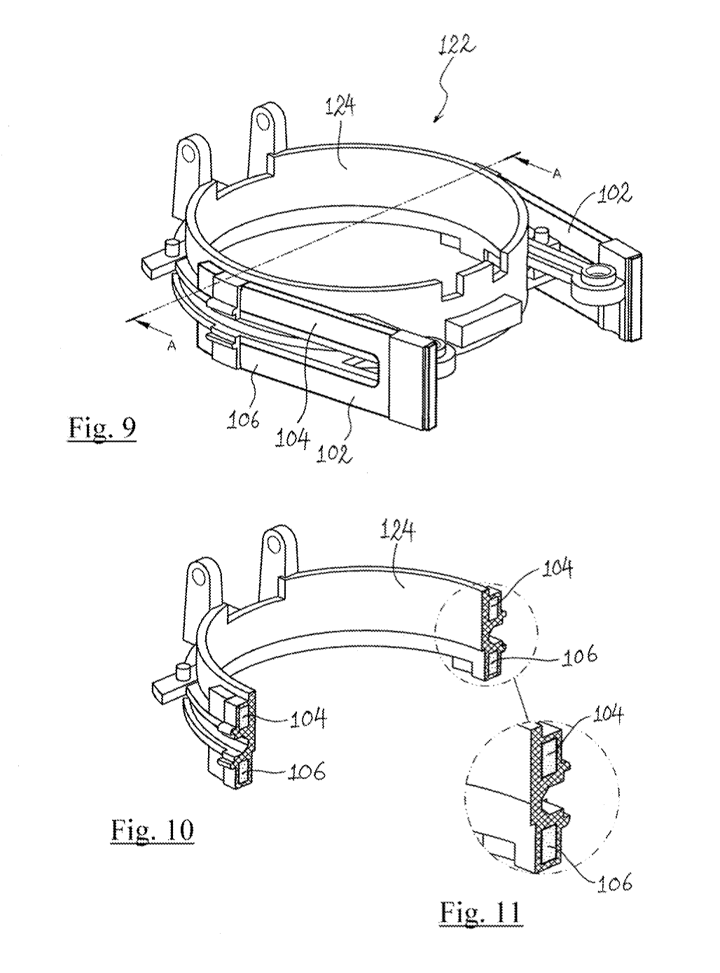

FIGS. 9 to 11 show a base, generally designated as 122, formed after the injection moulding process shown in FIGS. 7 and 8. The base 122 includes a core part 124 of a metal or metal alloy fixedly engaged with the two generally U-shaped steel plates 102. In particular, it can be seen that part of the core part 124 are moulded over and around the troughs 108, 110, 114, 116 so that the core part 124 is in direct contact with the U-shaped steel plates 102.

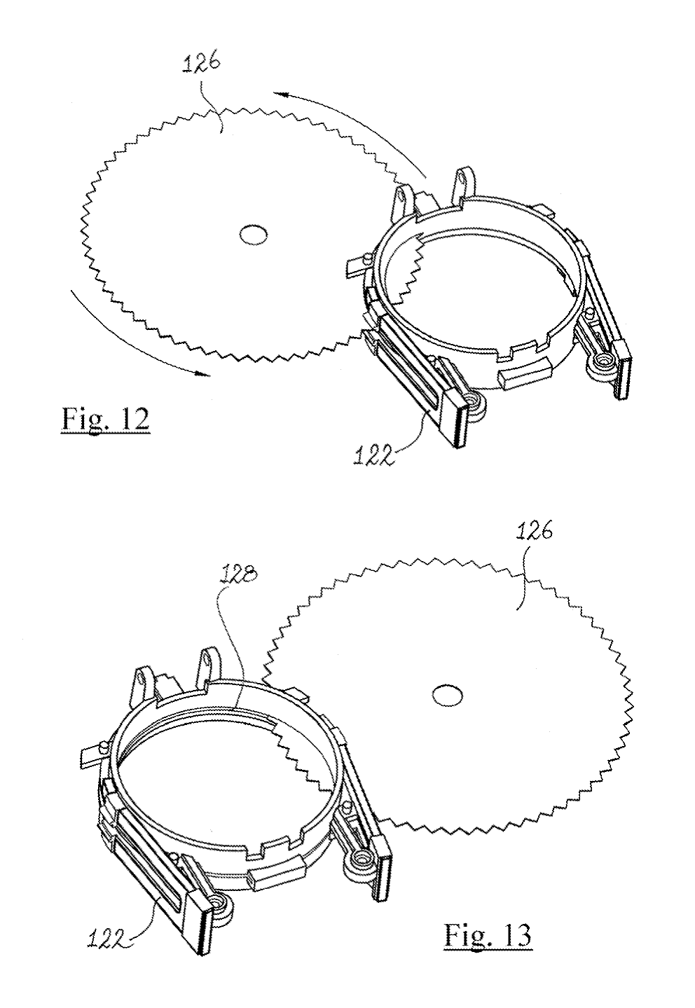

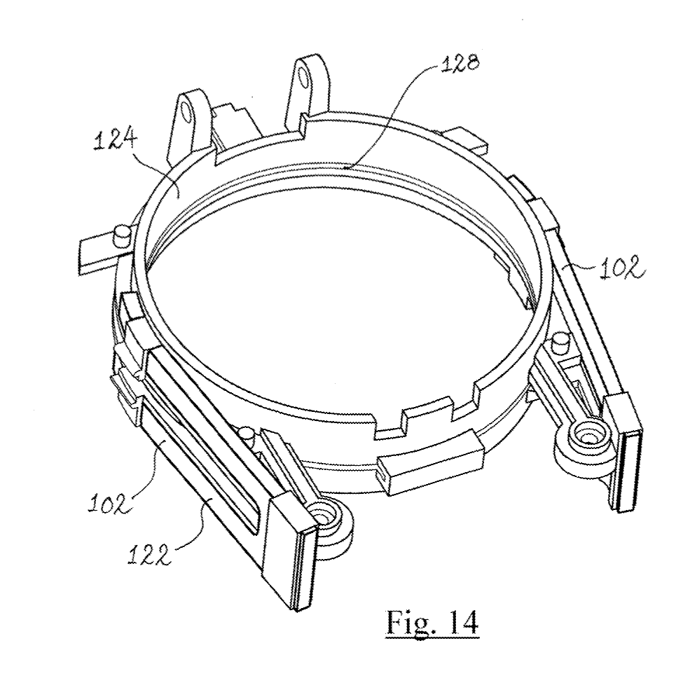

As shown in FIGS. 12 and 13, a circular saw 126 is then operated to cut open a slot 128 at a front end of the base 122 which, when the base 122 is incorporated into a paper punch, allows insertion of pieces of paper or cardboard therein. The base 122 so formed is shown in FIG. 14.

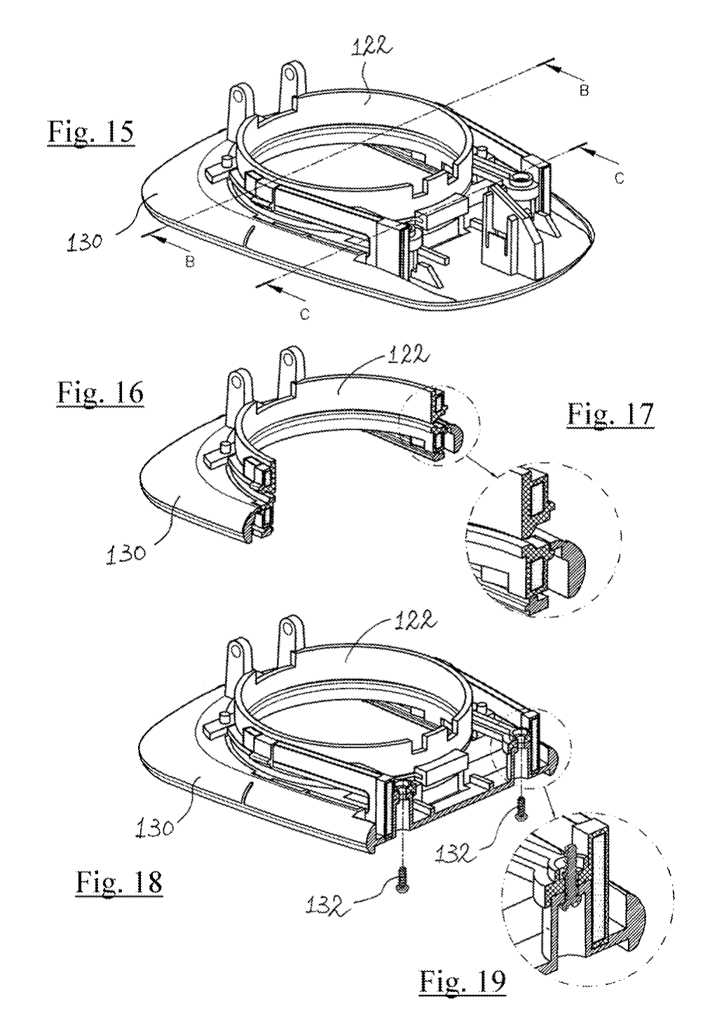

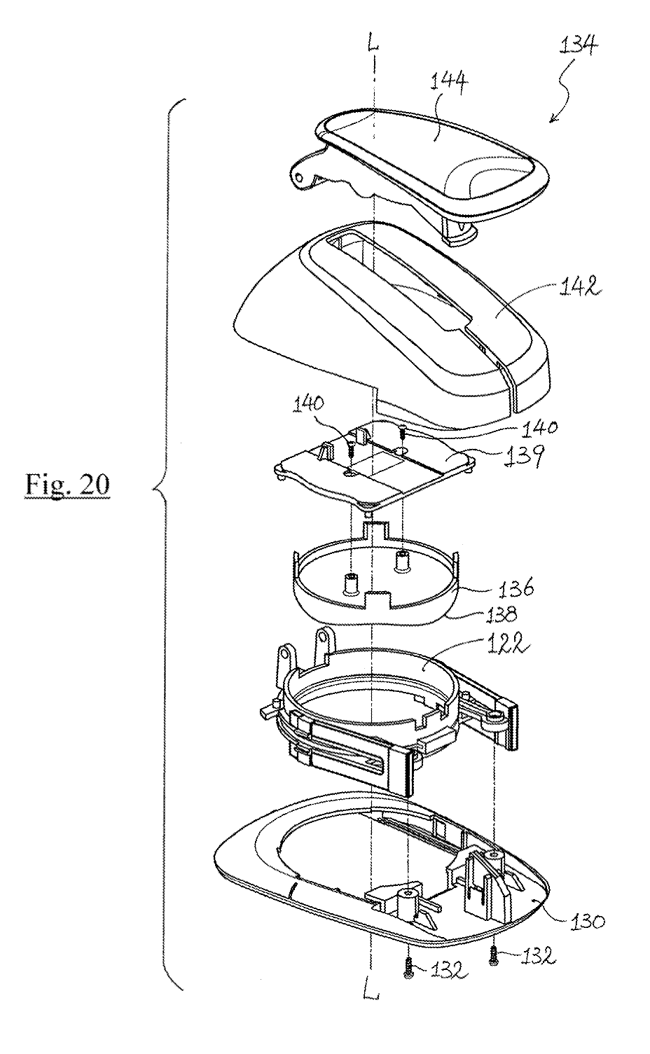

Turning now to FIGS. 15 to 19, such show the base 122 fixedly engaged with a bottom plate 130, which may be made of a metal, metal alloy or plastics material. In particular, as shown in FIGS. 18 and 19, the base 122 is fixedly engaged with the bottom plate 130 by two screws 132.

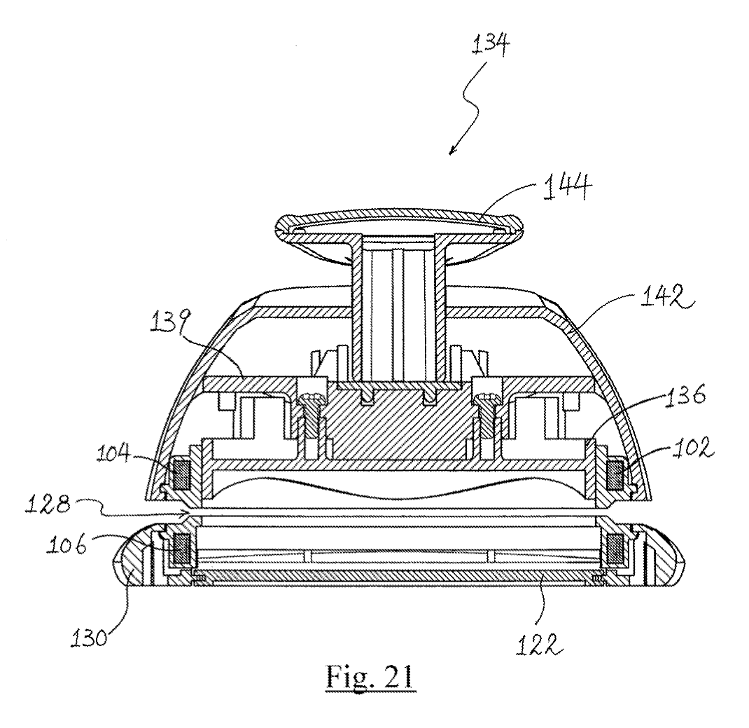

FIGS. 20 and 21 show a paper punch, generally designated as 134, incorporating the base 122 and the bottom plate 130. A metal or metal alloy die 136 with a cutting edge 138 is provided, which is movable relative to the base 122 to cut pieces of paper or cardboard inserted into the slot 128 of the base 122. The die 136 is fixedly secured with a top plate 139 by a pair of screws 140. A cover 142 is positioned to cover the bottom plate 130, the base 122, the die 136 and the top plate 139, and an operating handle 144 is pivotably engaged with the cover 142 and bears on the top plate 139. By way of such an arrangement, pivotal movement of the operating handle 144 relative to the cover 142 will bring about movement of the die 136 and the top plate 139 along the central axis L-L relative to the base 122 to perform cutting action.

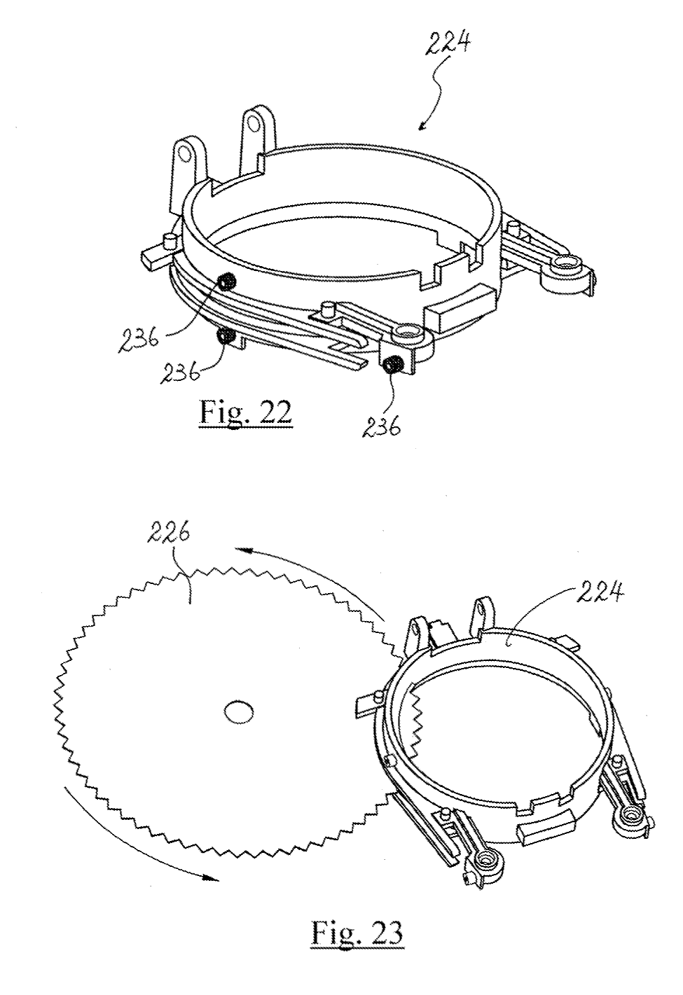

A core part suitable for forming a base for a paper punch according to a second embodiment of the present invention is shown in FIG. 22, generally designated as 224. The core part 224 is made integrally of a metal or metal alloy, such as copper, aluminium, silver, zinc, tin or their alloy. On each lateral side of the core part 224 are three centrally hollow sideward-extending extensions 246. All these extensions 246 are internally threaded.

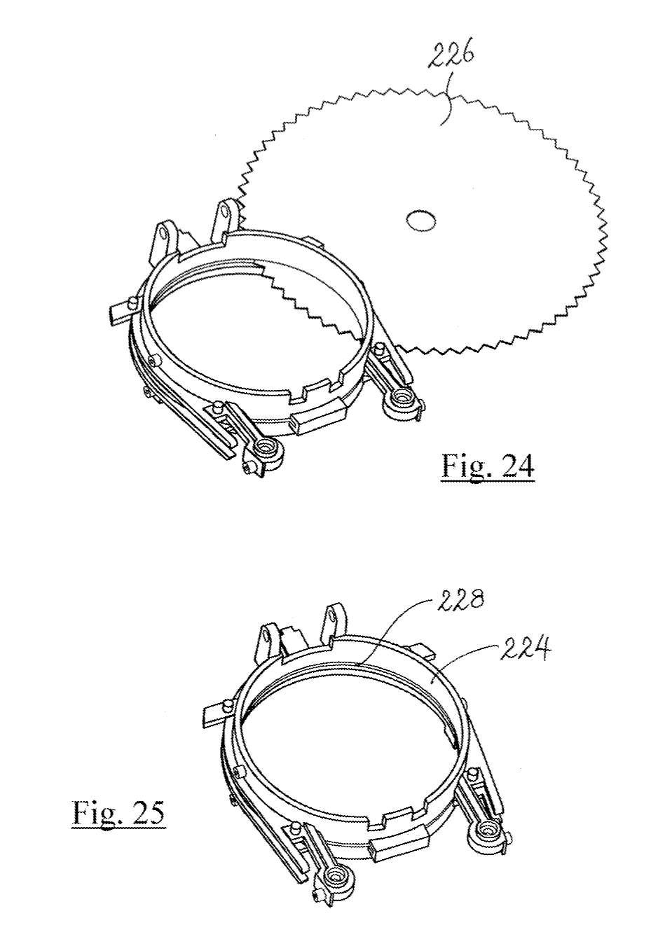

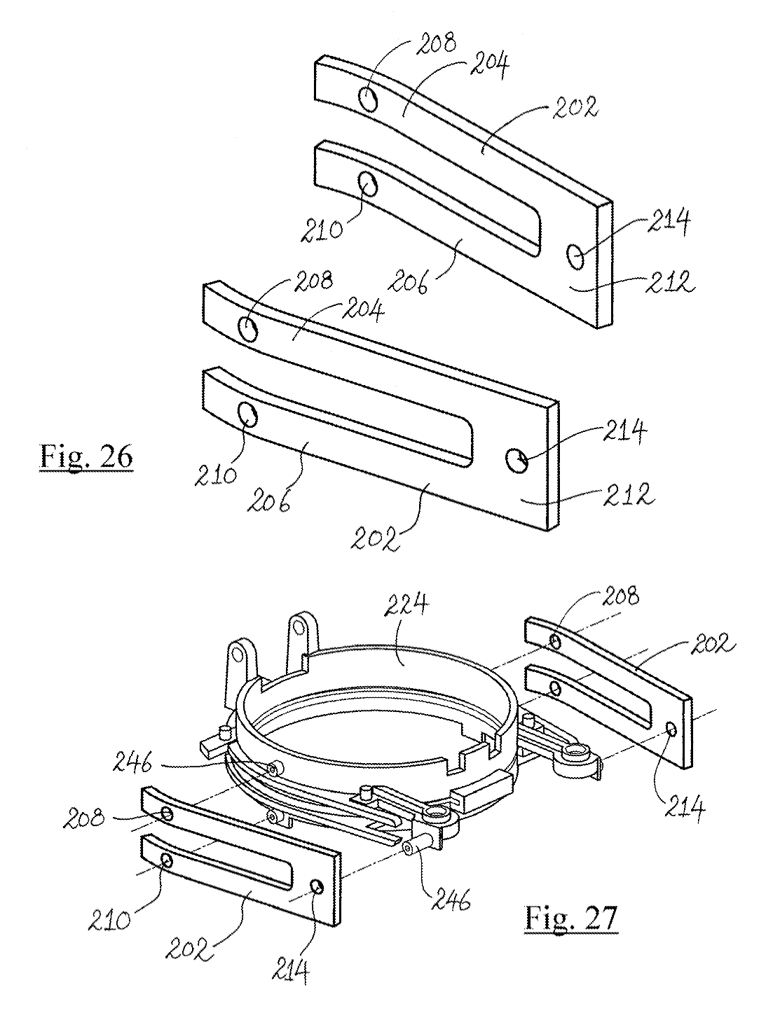

As shown in FIGS. 23 and 24, a circular saw 226 is operated to cut open a slot 228 in the core part 224, as shown in FIG. 25. Two integrally formed generally U-shaped steel plates 202 are provided, as shown in FIG. 26, each having a first leg 204 and a second leg 206 which are parallel with each other. Adjacent a free end of each first leg 204 is a hole 108, and adjacent a free end of each second leg 206 is also a hole 210. For each steel plate 202, the first leg 204 is joined with the respective second leg 206 via a generally rectangular portion 212. The rectangular portion 212 is also provided with a hole 214.

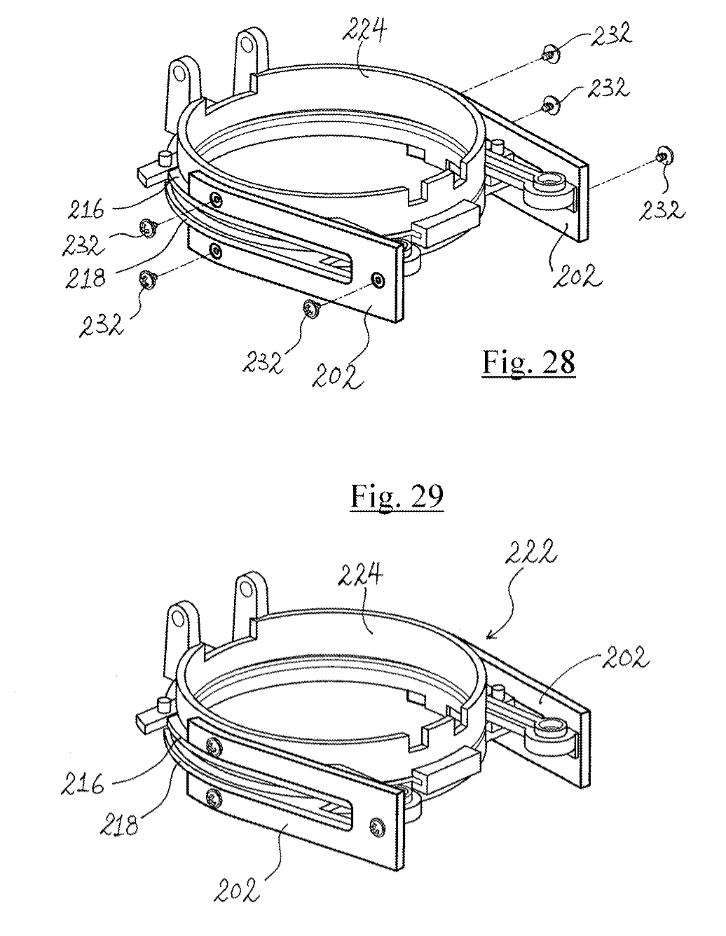

The extensions 246 of the core part 224 and the holes 208, 210, 214 of the steel plates 202 are sized, configured and positioned such that, as shown in FIG. 27, each of the holes 208, 210, 214 of a respective steel plate 202 is adapted to receive a respective extension 246 therethrough. When the steel plates 202 are thus engaged and in direct contact with the core part 224, screws 232 (see FIG. 28) may then be fastened into the extensions 246 to fixedly engage the steel plate 202 with the core part 224, as shown in FIG. 29, to form a base 222 for a paper punch. It can be seen that, when so assembled, the first leg 204 of each steel plate 202 is fixedly engaged with an upper jaw 216 of the core part 224 and the second leg 206 of each steel plate 202 is fixedly engaged with a lower jaw 218 of the core part 224.

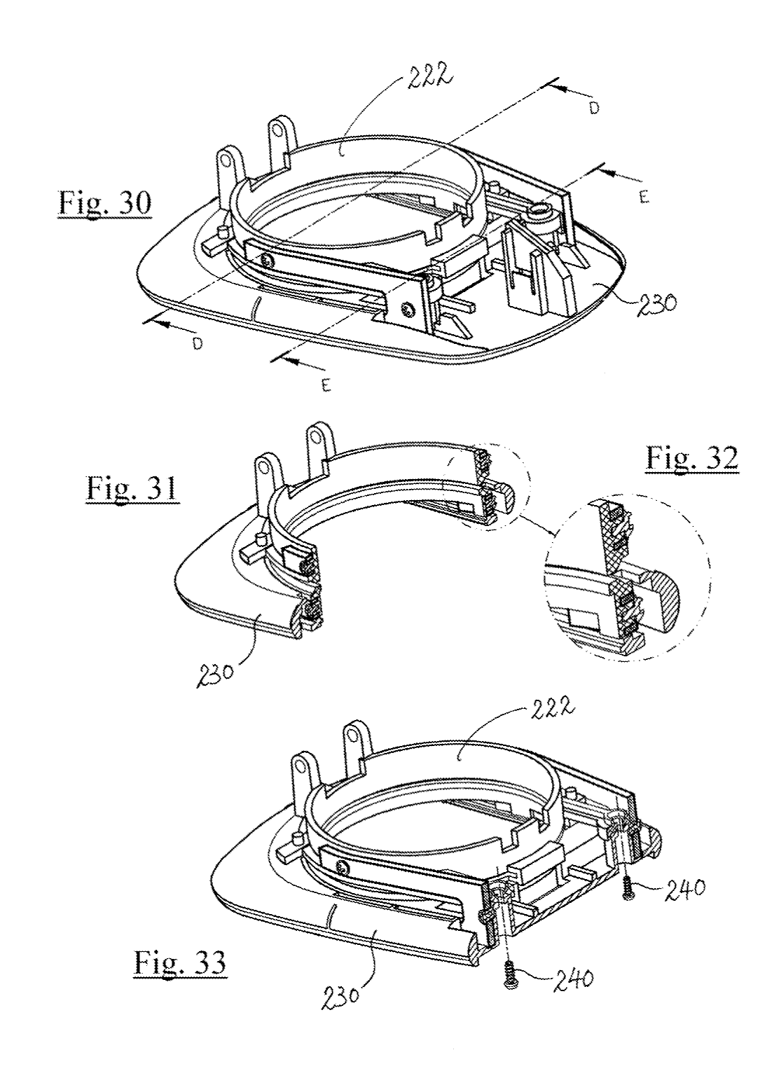

Turning now to FIGS. 30 to 33, such show the base 222 fixedly engaged with a bottom plate 230, which may be made of a metal, metal alloy or plastics material. In particular, as shown in FIG. 33, the base 222 is fixedly engaged with the bottom plate 230 by two screws 240.

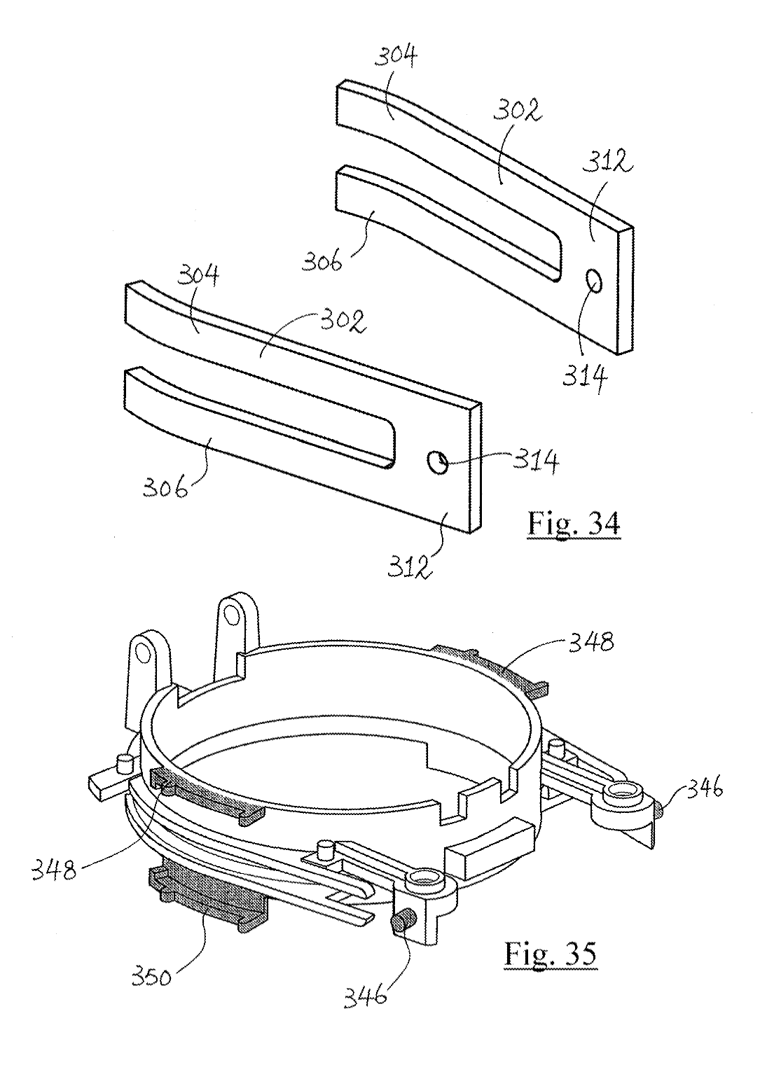

Referring now to FIG. 34, such shows two integrally formed generally U-shaped steel plates 302, suitable for incorporation in a base for forming a paper punch according to a third embodiment of the present invention. Each steel plate 302 has a first leg 304 and a second leg 306 which are parallel with each other. For each steel plate 302, the first leg 304 is joined with the respective second leg 306 via a generally rectangular portion 312. The rectangular portion 112 is provided with an aperture 314.

FIG. 35 shows a core part 324 which may be integrally formed of a metal or metal alloy, such as copper, aluminium, silver, zinc, tin or their alloy. On each lateral side of the core part 324 is a sideward-extending stud 346, an upper hook portion 348 and a lower hook portion 350.

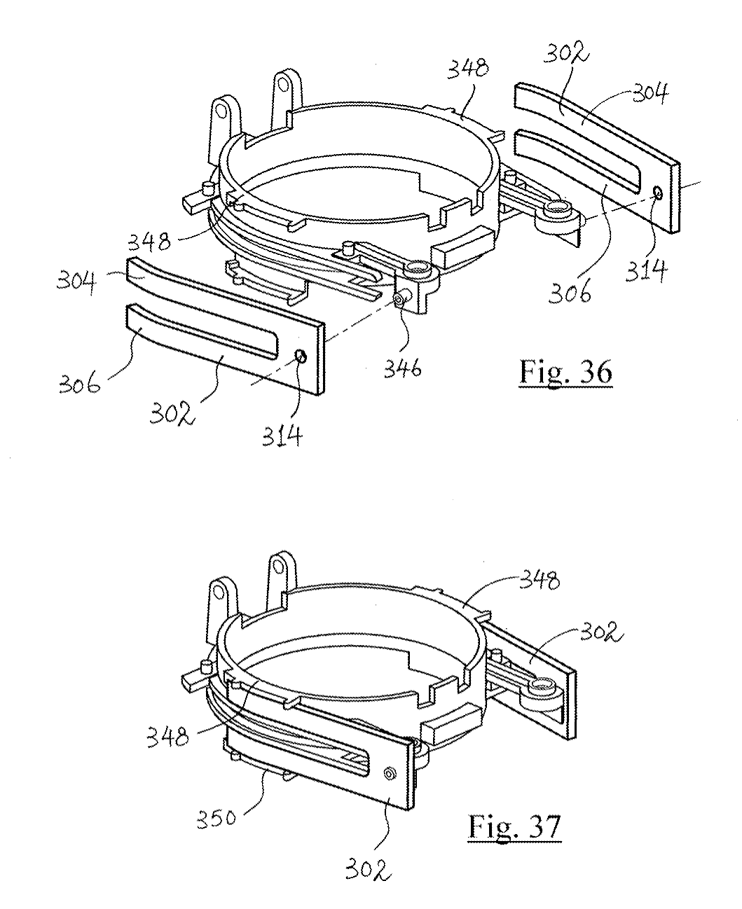

As shown in FIGS. 36 and 37, the studs 346, upper hook portions 348 and lower hook portions 350 may be so sized, positioned and configured such that each stud 346 is received within a respective aperture 314 of the plate 302, the first leg 304 is in contact with and under the upper hook portion 348, and the second leg 306 is in contact with and on the lower hook portion 350.

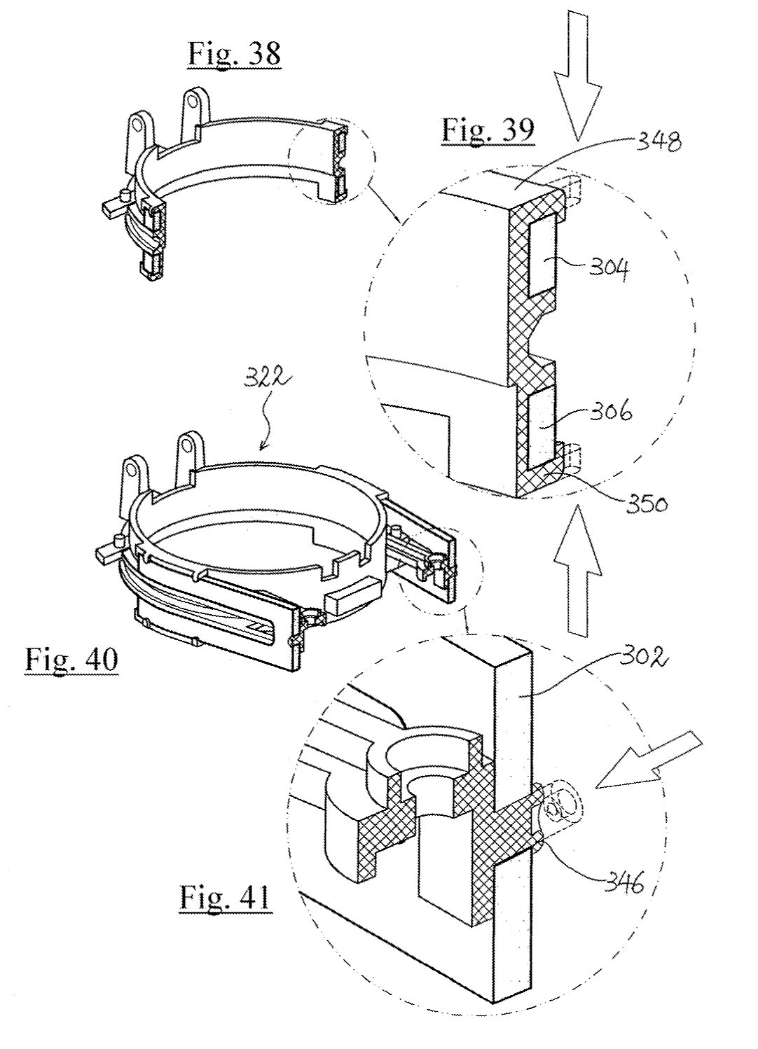

As shown in FIGS. 38 and 29, the upper hook portions 348 are then deformed, e.g. bent downward, to fixedly engage with and hold the first legs 304 of the plates 302. Similarly, the lower hook portions 350 are deformed, e.g. bent upward, to fixedly engage with and hold the second legs 306 of the plates 302. As shown in FIGS. 40 and 41, the studs 346 act as rivets and are deformed to secure the steel plates 302 to the core part 324 to form a base 322.

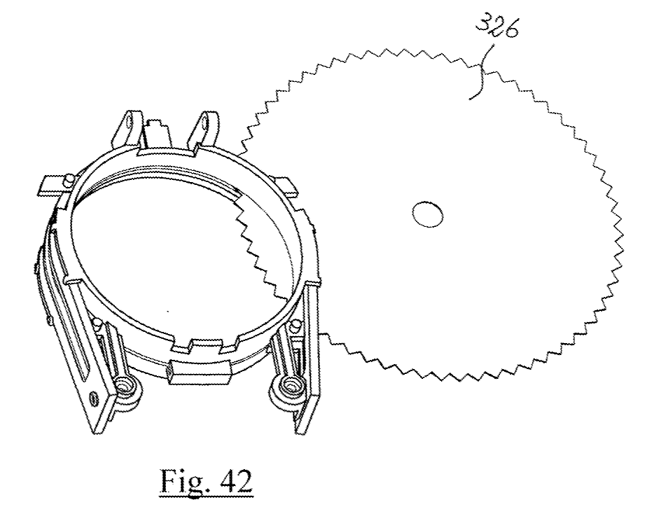

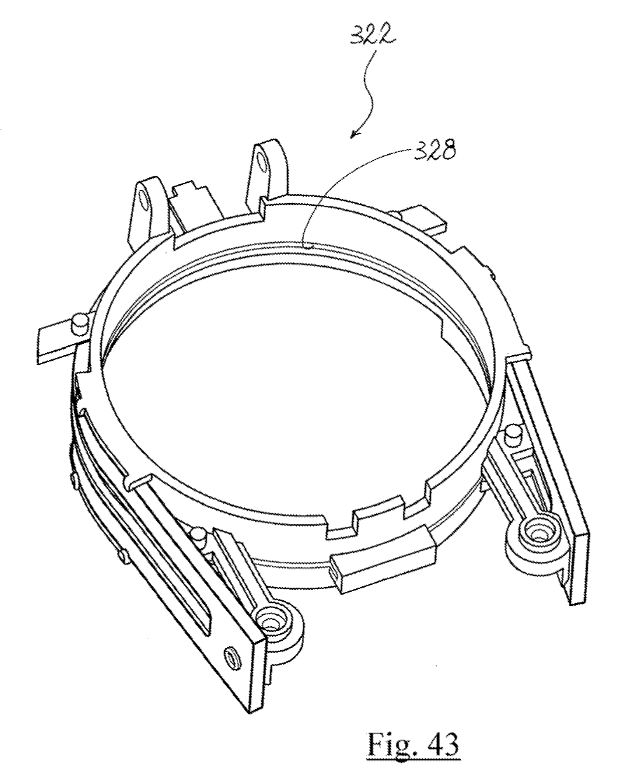

A circular saw 326 (see FIG. 42) may then be operated to cut open a slot 328 (see FIG. 43) through the base 322 to allow insertion of pieces of paper or cardboard when the base 322 is incorporated in a paper punch.

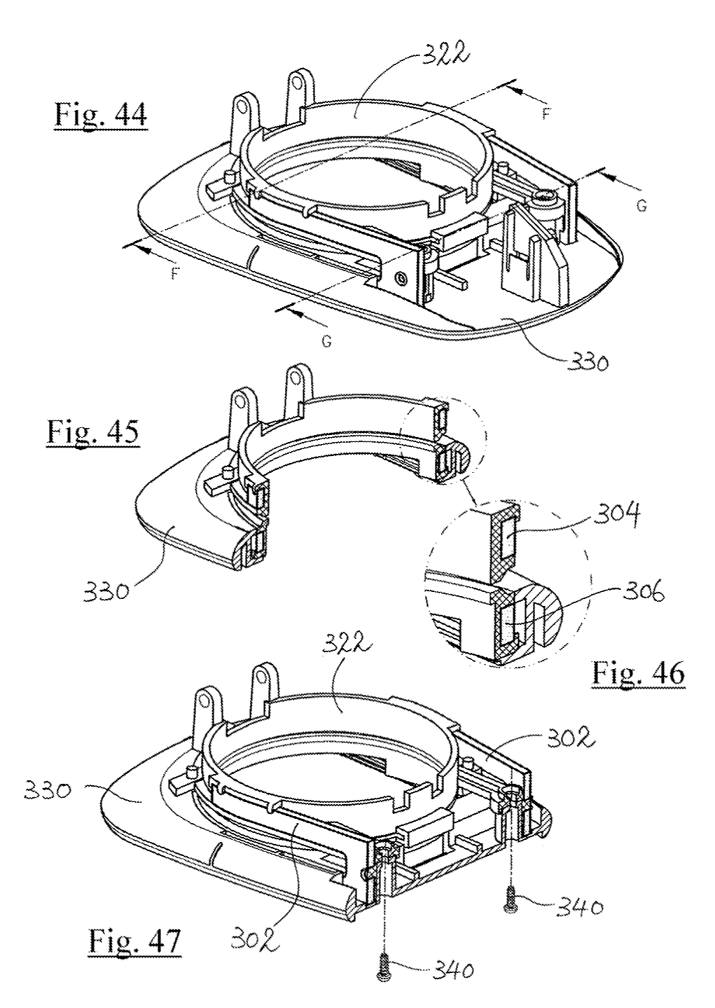

Turning now to FIGS. 44 to 47, such show the base 322 fixedly engaged with a bottom plate 330, which may be made of a metal, metal alloy or plastics material. In particular, as shown in FIG. 47, the base 322 is fixedly engaged with the bottom plate 330 by two screws 340.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A method of forming a base for a paper punch, including the steps of:
(a) forming at least two generally U-shaped plate members of a first metal or metal alloy, and
(b) fixedly engaging said generally U-shaped plate members with a core part of a second metal or metal alloy,
wherein at least part of each said plate members is in direct contact with at least part of said core part.

2. A method according to claim 1 wherein said U-shaped plate members are made at least principally of steel.

3. A method according to claim 1 wherein in said step (b), said second metal or metal alloy is moulded onto said U-shaped plate members to form a core part in direct contact and fixedly engaged with said plate members.

4. A method according to claim 3 further including a step (c), after said steps (a) and (b), of forming a slot through said core part.

5. A method according to claim 4 further including a step (d) of fixedly engaging said core part with a bottom plate.

6. A method according to claim 1 wherein in said step (b), said plate members are fixedly engaged with said core part by fixing means.

7. A method according to claim 6 wherein each said plate member is provided with at least one aperture adapted to receive said fixing means therethrough for fixedly engaging said plate member with said core part.

8. A method according to claim 7 wherein said fixing means comprising a screw or a rivet.

9. A method according to claim 6 wherein each said plate member has a first leg member and a second leg member, and wherein in said step (b), said first leg member is fixedly engaged by said fixing means with an upper jaw of said core part and said second leg member is fixedly engaged by said fixing means with a lower jaw of said core part.

10. A method according to claim 9 further including a step (e) of fixedly engaging said core part with a bottom plate.

11. A method according to claim 1 wherein said core part includes at least a first deformable part and a second deformable part adapted to be deformed to fixedly engage with one of said plate members.

12. A method according to claim 11 wherein in said step (b), said first deformable part is deformed to fixedly engaged with a first leg member of said plate member and said second deformable part is deformed to fixedly engage with a second leg member of said plate member.

13. A base for a paper punch, including:
at least two generally U-shaped plate members of a first metal or metal alloy, and
a core part of a second metal or metal alloy which is fixedly engaged with said U-shaped plate members,
wherein at least part of each said plate members is in direct contact with at least part of said core part.

14. A base according to claim 13 wherein said U-shaped plate members are made at least principally of steel.

15. A base according to claim 13 wherein said plate members are fixedly engaged with said core part by fixing means.

16. A base according to claim 15 wherein each said plate member includes at least one aperture receiving said fixing means therethrough for fixedly engaging said plate member with said core part.

17. A base according to claim 15 wherein said fixing means comprises at least a screw or rivet.

18. A base according to claim 13 wherein each said plate member has a first leg member and a second leg member, and wherein said first leg member is fixedly engaged by said fixing means with an upper jaw of said core part and said second leg member is fixedly engaged by said fixing means with a lower jaw of said core part.

19. A base according to claim 13 wherein said core part includes at least a first deformable part and a second deformable part deformed to fixedly engage with one of said plate members.

20. A base according to claim 19 wherein said first deformable part is deformed to fixedly engaged with a first leg member of said plate member and said second deformable part is deformed to fixedly engage with a second leg member of said plate member.

21. A paper punch including a die and a base formed by a method according to claim 1.

22. A paper punch including a die and a base according to claim 13.

23. A method according to claim 7 wherein each said plate member has a first leg member and a second leg member, and wherein in said step (b), said first leg member is fixedly engaged by said fixing means with an upper jaw of said core part and said second leg member is fixedly engaged by said fixing means with a lower jaw of said core part.

24. A method according to claim 23 further including a step (e) of fixedly engaging said core part with a bottom plate.

25. A method according to claim 8 wherein each said plate member has a first leg member and a second leg member, and wherein in said step (b), said first leg member is fixedly engaged by said fixing means with an upper jaw of said core part and said second leg member is fixedly engaged by said fixing means with a lower jaw of said core part.

26. A method according to claim 25 further including a step (e) of fixedly engaging said core part with a bottom plate.

27. A base according to claim 16 wherein said fixing means comprises at least a screw or rivet.
